(19) United States
(12) Patent Application Publication
(10) Pub. No.: US 2024/0166470 A1
(43) Pub. Date: May 23, 2024

(54) Distributed Screw and Nut Drive Systems with Synchronized Motors for Lifts

(71) Applicant: Karen Virk, Toronto (CA)

(72) Inventor: Karen Virk, Toronto (CA)

(21) Appl. No.: 18/204,928

(22) Filed: Jun. 1, 2023

Related U.S. Application Data
(60) Provisional application No. 63/384,825, filed on Nov. 23, 2022.
(60) Provisional application No. 63/384,820, filed on Nov. 23, 2022.

(51) Int. Cl. B66B 11/04; B66B 1/30; B66B 1/34

(52) U.S. Cl. CPC B66B 11/0446; B66B 1/30; B66B 1/343; B66B 1/3492

(57) ABSTRACT

Distributed drive systems with synchronized motors in accordance with embodiments of the invention are disclosed. In one embodiment, a distributed drive system for a lift is provided, the distributed drive system comprising: a first drive unit comprising: a first drive unit screw, a first motor unit concentric to the first drive unit screw, and a first drive unit nut in contact with the first drive unit screw and a carrying platform of the lift; a second drive unit comprising: a second drive unit screw, a second motor unit concentric to the second drive unit screw, and a second drive unit nut in contact with the second drive unit screw and the carrying platform of the lift; and a control feedback module operatively connected to the first and second drive units, wherein the control feedback module is configured to synchronize the first motor unit and the second motor unit.

### CROSS-REFERENCE TO RELATED APPLICATIONS

The current application claims priority to Provisional Patent Application No. 63/384,825 filed on Nov. 23, 2022 and Provisional Patent Application No. 63/384,820 filed on Nov. 12, 2022, the disclosures of which are incorporated herein by reference.

### FIELD OF THE INVENTION

The present invention generally relates to lifts and more specifically to distributed screw and nut drive systems utilizing synchronous rotational motion of a plurality of screws and/or nuts via concentric, direct drive motors.

### BACKGROUND

A lift (e.g., an elevator, conveyor, hoist, dumbwaiter, etc.) is a mechanical device designed to transport people or goods vertically between floors in a building. The majority of lifts are commonly divided into either electric lifts or hydraulic lifts. Generally, electric lifts are traction lifts in which the carrying platform is pulled via ropes by traction in the grooves of a driving sheave balanced with a counterweight system. Alternatively, hydraulic lifts typically use a piston system to push the carrying platform or pull the carrying platform via a roping system. Strict safety requirements for lifts are set by various standards and often dictate the appropriate drive system. However, regardless of the classification, all lifts typically have power to: lift and lower the load (e.g., people, objects, etc.) being transported by the carrying platform, lift and lower the weight of the carrying platform, and overcome the inherent friction of the system.

A hoistway is the shaft (e.g., vertical shaft, hoistway, runway etc.) through which the lift travels. Typically, the hoistway extends from the pit at the bottom of the shaft, where the lift rests when not in use, to the overhead space at the top of the shaft where a counterweight is usually located if used and if the lift rests at the bottom of the shaft.

### SUMMARY OF THE INVENTION

The various embodiments of the present distributed screw and nut drive systems with synchronized motors (may also be referred to herein as “distributed drive systems”) contain several features, no single one of which is solely responsible for their desirable attributes. Without limiting the scope of the present embodiments, their more prominent features will now be discussed below. In particular, the present distributed drive systems will be discussed in the context of lifts (e.g., elevators, conveyors, hoists, dumbwaiters, etc.). However, the description of distributed drive systems in the context of lifts is merely exemplary and various other mechanical devices designed to transport people or goods may be utilized with distributed drive systems as appropriate to the requirements of a specific application in accordance with various embodiments of the invention. After considering this discussion, and particularly after reading the section entitled “Detailed Description,” one will understand how the features of the present embodiments provide the advantages described here.

One aspect of the present embodiments includes the realization that in current lifts other than the present embodiments, lifts are mechanically complex and often occupy significant space, typically requiring space far above minimum code requirements; thus, they are very expensive. For example, many lifts require increased hoistway heights or deeper pits to fit their drive system components, and many others additionally require machine rooms to operate the lift. The present embodiments solve this problem through a distributed screw and nut drive system with synchronized motors. The present embodiments thus advantageously enable a drive system for a lift that is both simple enough in design to easily allow a lift to be placed anywhere in a building without significant modifications to the building, and that includes machinery compacted within the minimum allowable hoistway height. The present embodiments provide these advantages and enhancements, as described below.

In a first aspect, a distributed drive system for a lift is provided, the distributed drive system comprising: a first drive unit comprising: a first drive unit screw comprising a helical thread, wherein the first drive unit screw is oriented along a hoistway of the lift; a first motor unit concentric to the first drive unit screw, wherein the first motor unit is configured to rotate the first drive unit screw; and a first drive unit nut in contact with the first drive unit screw and in contact with a carrying platform of the lift, wherein the first drive unit nut is configured to travel a length of the helical thread of the first drive unit screw as the first drive unit screw rotates, causing the first drive unit nut to travel along the hoistway of the lift; a second drive unit comprising: a second drive unit screw comprising a helical thread, wherein the second drive unit screw is oriented along the hoistway of the lift; a second motor unit concentric to the second drive unit screw, wherein the second motor unit is configured to rotate the second drive unit screw; and a second drive unit nut in contact with the second drive unit screw and in contact with the carrying platform of the lift, wherein the second drive unit nut is configured to travel a length of the helical thread of the second drive unit screw as the second drive unit screw rotates, causing the second drive unit to travel along the hoistway of the lift; and a control feedback module operatively connected to the first and second drive units, wherein the control feedback module is configured to synchronize position or rotary speed of the first motor unit and the second motor unit.

In an embodiment of the first aspect, the control feedback module comprises a controller, and wherein the controller is configured to: send a control signal to the first drive unit; send an enable signal to the second drive unit; and monitor the first motor unit and the second motor unit.

In another embodiment of the first aspect, the first drive unit further comprises a first drive module configured to: receive the control signal from the controller; send first drive voltage to the first motor unit; and send an operational feedback signal.

In another embodiment of the first aspect, the second drive unit further comprises a second drive module configured to: receive the operational feedback signal from the first drive module; receive the enable signal from the controller; and send second drive voltage to the second motor unit.

In another embodiment of the first aspect, the first drive unit further comprises a first motor encoder configured to: encode a first set of error feedback data into a first encoder feedback signal; and send the first encoder feedback signal from the first motor unit to the first drive module.

In another embodiment of the first aspect, the second drive unit further comprises a second drive module configured to: receive the operational feedback signal from the first drive module; receive the enable signal from the controller; and send a second drive signal to the second motor unit.

In another embodiment of the first aspect, the second drive unit further comprises a second motor encoder configured to: encode a second set of error feedback data into a second encoder feedback signal; and send the second encoder feedback signal from the second motor unit to the second drive module.

In another embodiment of the first aspect, the first drive unit further comprises a first brake that is engaged by default and is released by the first drive module.

In another embodiment of the first aspect, the second drive unit further comprises a second brake that is engaged by default and is released by the second drive module.

In another embodiment of the first aspect, the first brake is attached to the first motor unit, and the second brake is attached to the second motor unit.

In another embodiment of the first aspect, the distributed drive system further comprises an at least one suspension frame, wherein the at least one suspension frame comprises a side having a length.

In another embodiment of the first aspect, the at least one suspension frame comprises an at least one guide rail oriented along the length of the at least one suspension frame, and wherein the at least one guide rail restricts the carrying platform to a single axis of movement and keeps the carrying platform aligned with landing floors.

In another embodiment of the first aspect, the single axis of movement of the carrying platform is along the at least one guide rail.

In another embodiment of the first aspect, the at least one guide rail is oriented parallel to the first drive unit screw and the second drive unit screw.

In another embodiment of the first aspect, the at least one suspension frame further comprises an at least one limit member guide in contact with the at least one guide rail and in contact with the carrying platform, and wherein the at least one limit member guide maintains the carrying platform's alignment and stability as the carrying platform travels along the at least one guide rail.

In another embodiment of the first aspect, the first drive unit screw is suspended in tension along the length of the at least one suspension frame, and the second drive unit screw is suspended in tension along the length of the at least one suspension frame.

In another embodiment of the first aspect, the distributed drive system further comprising: a first suspension nut in contact with the first drive unit screw and in contact with the at least one suspension frame; and a second suspension nut in contact with the second drive unit screw and in contact with the at least one suspension frame.

In another embodiment of the first aspect, the first motor unit is attached to the at least one suspension frame, and the second motor unit is attached to the at least one suspension frame.

In another embodiment of the first aspect, the first motor unit is a first torque motor unit, and the second motor unit is a second torque motor unit.

In another embodiment of the first aspect, the first torque motor unit comprises a first rotor and a first stator, and wherein the second torque motor unit comprises a second rotor and a second stator.

In another embodiment of the first aspect, the first rotor is attached to the first drive unit screw via a first coupling, and wherein the second rotor is attached to the second drive unit screw via a second coupling.

### BRIEF DESCRIPTION OF THE DRAWINGS

The various embodiments of the present distributed drive systems now will be discussed in detail with an emphasis on highlighting the advantageous features. These embodiments depict the novel and non-obvious distributed drive systems shown in the accompanying drawings, which are for illustrative purposes only. These drawings include the following figures:

FIG. 1 is a schematic diagram illustrating a right perspective view of a stationary motor distributed drive system in accordance with an embodiment of the invention.

FIG. 2 is a schematic diagram illustrating a cross-section view of a drive unit of a stationary motor distributed drive system for a lift in accordance with an embodiment of the invention.

FIGS. 3A-B are schematic diagrams illustrating a left perspective view of alternative embodiments of stationary motor distributed drive systems for a lift in accordance with an embodiment of the invention.

FIGS. 4A-C are schematic diagrams illustrating a right perspective view of other alternative embodiments of stationary motor distributed drive systems for a lift in accordance with an embodiment of the invention.

FIG. 5 is a schematic diagram illustrating a left perspective view of a traveling motor distributed drive system for a lift in accordance with an embodiment of the invention.

FIG. 6 is a schematic diagram illustrating a cross section view of a drive unit of a traveling motor distributed drive system for a lift in accordance with an embodiment of the invention.

FIGS. 7A-E are schematic diagrams illustrating a left perspective view of alternative embodiments of traveling motor distributed drive systems for a lift in accordance with an embodiment of the invention.

FIGS. 8A-B are schematic diagrams illustrating a cross-section view of alternative embodiments of a drive unit of traveling motor distributed drive systems for a lift in accordance with an embodiment of the invention.

FIG. 9 is a block diagram illustrating a control feedback module of a distributed drive system for a lift in accordance with an embodiment of the invention.

FIG. 10 is a flow diagram illustrating a process of synchronization monitoring of a first and second drive units by a controller in accordance with an embodiment of the invention.

FIG. 11 is a flow diagram illustrating a process of motor synchronization by a first drive module in accordance with an embodiment of the invention.

FIG. 12 is a flow diagram illustrating a process of motor synchronization by a second drive module in accordance with an embodiment of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features.

Turning now to the drawings, distributed screw and nut drive systems (may also be referred to herein as “distributed drive systems”) for lifts (e.g., elevators, conveyors, hoists, dumbwaiters, etc.) utilizing synchronous rotational motion in accordance with embodiments of the invention are illustrated. In various embodiments, the distributed drive systems may utilize synchronous rotational motion of a plurality of drive unit screws and/or drive unit nuts to move a carrying platform of the lift. In many embodiments, distributed drive systems may include a first drive unit, a second drive unit, and a control feedback module in allowing for synchronous rotational motion of drive unit screws and/or drive unit nuts, as further described below. For example, in several embodiments, the drive units (e.g., the first drive and/or second drive units) may comprise a drive unit screw, a motor unit, and a drive unit nut. In some embodiments, the drive unit screw is oriented along the hoistway of the lift and the motor unit is concentric to the drive unit screw.

In various embodiments, the distributed drive systems may be configured as stationary motor distributed drive systems (hereinafter referred to as “stationary motor drive systems”), wherein the motor unit is stationary in position and rotates the drive unit screw. In many embodiments, the drive unit nut is in contact with the drive unit screw and in contact with the carrying platform of the lift, such that the load of the carrying platform rests on the drive unit nut and the drive unit nut is secured against rotational motion. As further described herein, the drive unit nut is configured to travel a length of the helical thread of the drive unit screw as the motor unit rotates the drive unit screw through the drive unit nut. This movement of the drive unit nut moves the carrying platform along the length of the drive unit screw.

In addition, the first motor unit and second motor unit are synchronized with one another via the control feedback module, as further described below. The use of synchronized motors may serve to limit the load on each motor, decrease the power required to move the carrying platform, and/or reduce the number of mechanical elements per drive unit. In many embodiments, the motor unit may be attached to a suspension frame, and the drive unit screw may be suspended in tension along a length of the suspension frame.

In some embodiments, distributed drive systems may also be configured as traveling motor distributed drive systems (hereinafter referred to as “traveling motor drive systems”) such that the entire motor unit and carrying platform are configured to climb the helical thread of the drive unit screw. In many embodiments, the motor unit(s) may be affixed to the carrying platform and encircle a drive unit screw such that the motor unit rotates the drive unit nut instead of the drive unit screw. By encircling the drive unit screw with the motor unit, traveling motor drive systems may allow for further elimination of transmission elements, thereby reducing friction and increasing efficiency of the overall distributed drive system. In such embodiments, the drive unit nut may comprise a rotating inner ring attached to a rotor of the motor unit and a non-rotating outer ring attached to both a stator of the motor unit and the carrying platform. Thus, the rotor may rotate the inner ring, thereby causing the drive unit nut—and thus the entire motor unit and carrying platform—to climb the helical thread of the drive unit screw.

Further, in some embodiments, the carrying platform may rest entirely on the stator, eliminating the need for a non-rotating outer ring, such that the load of the carrying platform is borne entirely by bearings between the rotor and stator. In many embodiments, the drive unit screw may be suspended in tension along the hoistway of the lift with a suspension member and is secured in place against rotational motion via a suspension nut. In some embodiments, the suspension nut may be secured to the suspension member via a flange. Distributed drive systems utilizing synchronous rotational motion in accordance with embodiments of the invention are further discussed below.

### Stationary Motor Drive Systems

Stationary motor drive systems may include a motor unit that is stationary. For example, smaller lifts intended for short travel (e.g., accessibility lifts, residential elevators, commercial elevators, freight elevators, etc.) may use stationary motor drive systems. By designing such drive systems to distribute loads across a plurality of screws that are directly driven by a plurality of synchronized motors, the overall lift design may be simplified as fewer mechanical and transmission elements may be required for each drive unit. Consequently, both the overall friction of the system and maintenance needs may be reduced, and such distributed drive systems may allow for more flexible lift configurations that have reduced physical footprints (e.g., the sizes of the lifts would merely be limited by minimum code requirements for hoistway heights), thereby easing installation challenges. Moreover, synchronous rotational motion of directly driven screws and/or nuts may serve to decrease the overall power necessary to operate the lift, and the presence of multiple drive units may provide the lift with built in redundancies that permit the lift to operate even if certain drive components fail.

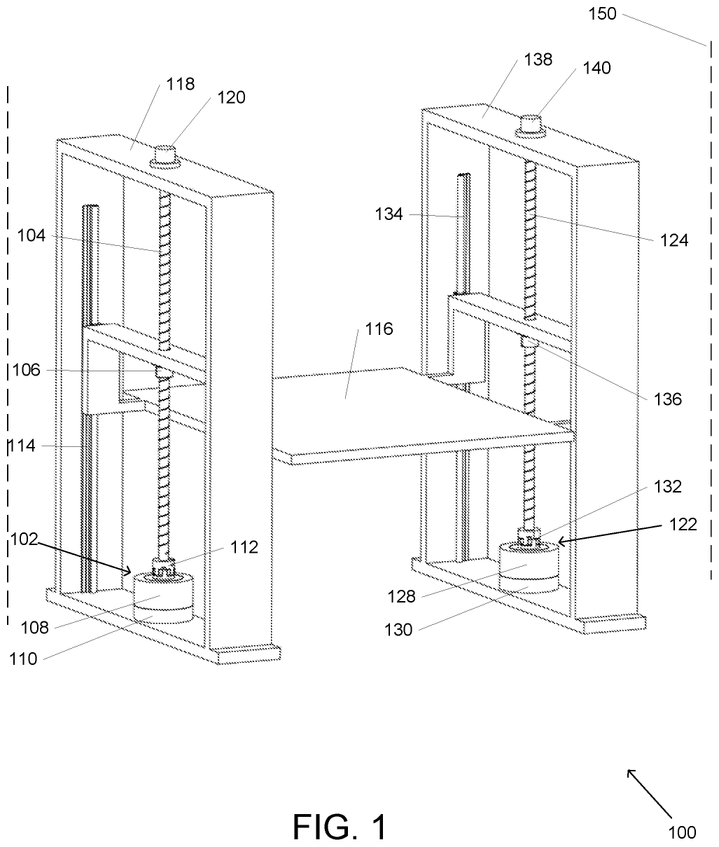

A schematic diagram illustrating a right perspective view of a stationary motor drive system in accordance with an embodiment of the invention is shown in FIG. 1. The stationary motor drive system 100 includes a first drive unit 102 that includes a first drive unit screw 104, a first motor unit 108, and a first drive unit nut 106. The stationary motor drive system 100 may also include a second drive unit 122 that includes a second drive unit screw 124, a second motor unit 128, and a second drive unit nut 136. The first motor unit 108 may be positioned concentrically to the first drive unit screw 104 and the first drive unit nut 106. In many embodiments, the first motor unit 108 may be configured to synchronously rotate the first drive unit screw 104, as further described below. In addition, the second motor unit 128 may be positioned concentrically to the second drive unit screw 124 and the second drive unit nut 136. In various embodiments, the second motor unit 128 may be configured to synchronously rotate the second drive unit screw 124, as further described below. In some embodiments, the first and second motor units 108, 128 may be torque motors such as (but not limited to) permanent magnet torque motors (hereinafter referred to as “PM torque motors”).

In reference to FIG. 1, the first and second motor units 108, 128 may be attached to the first and second drive unit screws 104, 124, respectively, via couplings 112, 132 that assist the first and second motor units 108, 128 in translating the rotational motion and torque generated by the motor units to the drive unit screws, as further discussed below. In many embodiments, the first and second drive units 102, 122 also include first and second brakes 110, 130, respectively, that are engaged by default and are released as the first and second motor units 108, 128 rotate the first and second drive unit screws 104, 124, respectively. In some embodiments, the first and second brakes 110, 130 are attached to the bottoms of the first and second motor units 108, 128, respectively, but may be located elsewhere, as further discussed below. In many embodiments, the first and second drive unit screws 104, 124 are oriented along the hoistway 150 of the lift, and the first and second drive unit nuts 106, 136 are configured to travel the helical threads of the first and second drive unit screws 104, 124, respectively, as the screws rotate through the first and second drive unit nuts 106, 136.

In further reference to FIG. 1, the first and second drive unit nuts 106, 136 encircle the drive unit screws 104, 124, respectively, and are in contact with both the first and second drive unit screws 104, 124, respectively, and the carrying platform 116 of the lift. The first and second drive unit nuts 106, 136 may be secured to the carrying platform 116 to prevent the first and second drive unit nuts 106, 136 from also rotating as the first and second drive unit screws 104, 124 rotate through the first and second drive unit nuts 106, 136. In some embodiments, the first and second drive unit nuts 106, 136 may be secured to the carrying platform 116 using methods known to one of skill in the art such that the load of the carrying platform 116 rests on the first and second drive unit nuts 106, 136. Additionally, in some embodiments, the first and second drive unit nuts 106, 136 may be secured to the carrying platform 116 via thrust spherical plain bearings that further limit the moment on the drive unit nuts. When the first and second drive unit nuts 106, 136 travel along the helical threads of the first and second drive unit screws 104, 124, respectively, the carrying platform 116 may also travel along the hoistway 150 of the lift.

In further reference to FIG. 1, the stationary motor drive system 100 may include first and second suspension frames 118, 138 in which the first and second drive unit screws 104, 124 are suspended in tension and are secured at the top via first and second suspension nuts 120, 140, respectively. In many embodiments, the first and second suspension nuts 120, 140 may rest on the tops of the first and second suspension frames 118, 138 and may be secured to the first and second suspension frames via flanges. The first and second motor units 108, 128 and first and second brakes 110, 130 may be secured to the bottom of the first and second suspension frames 118, 138, respectively, using methods known to one of skill in the art (but may be located elsewhere on the first and second suspension frames) such that the first and second motor units are concentric to both the first and second drive unit screws 104, 124 and the first and second drive unit nuts 106, 136, respectively. Suspension frames such as those in FIG. 1 may permit attached and/or suspended components (e.g., motor units, drive unit screws, brakes, drive unit nuts, etc.) to be precisely aligned in various spatial planes (or along a single spatial plane), thereby simplifying alignment challenges when installing lifts in buildings and eliminating the need for extraneous mechanical parts to account for component misalignment. In some embodiments, the first and second suspension frames 118, 138 may also include first and second guide rails 114, 134, respectively, that limit the carrying platform's 116 movement to a single axis along the guide rails themselves and that keep the carrying platform aligned with landing floors. In many embodiments, the first and second guide rails 114, 134 may be oriented parallel to the first and second drive unit screws 104, 124, respectively. Moreover, the first and second guide rails 114, 134 may help to limit the moment on the first and second drive unit nuts 106, 136 as the carrying platform 116 travels.

As described above, some embodiments of distributed drive systems may utilize torque motors to rotate the drive unit screws and/or drive unit nuts. Torque motors such as PM torque motors have a large number of magnetic poles that allow for generation of high torque at low speeds. This permits motors that directly drive the screws to meet the various mechanical rotational speeds as required by the lift, and even maintain a stopped position without the need for brakes. Moreover, the torque output of PM torque motors is proportional to the square of the motor's rotor diameter; thus, a small increase in diameter may lead to a large increase in torque output. A limitation on the diameter may be the lateral distance between the screws and the hoistway. However, if the desired diameter cannot be obtained because there is insufficient lateral space, then the PM torque motor's length may be increased until sufficient torque is delivered as torque is linearly proportional to motor length.

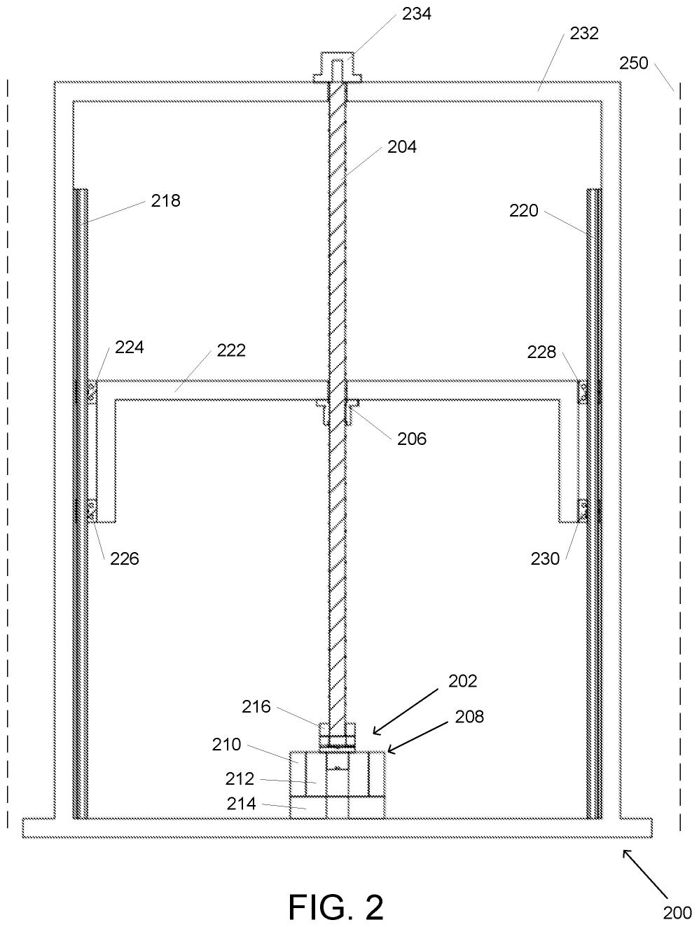

A schematic diagram illustrating a cross-section view of a drive unit of a stationary motor drive system in accordance with an embodiment of the invention is shown in FIG. 2. In many embodiments, the motor unit 208 is attached to the suspension frame 232 such that it is concentric to both the drive unit screw 204 and the drive unit nut 206. The drive unit screw 204 is suspended in tension within the suspension frame 232, and is secured at the top of the suspension frame with a suspension nut 234. In some embodiments, the motor unit 208 may be a torque motor unit that includes a rotor 212 that is attached to the drive unit screw 204 and a stator 210 that is attached to both the brake 214 and the suspension frame 232. In various embodiments, attaching the rotor 212 to the drive unit screw 204 such that the motor unit 208 directly drives the screw may eliminate the need for additional mechanical and transmission elements within the drive unit 202. Reducing the number of mechanical and transmission elements, as well as using short and wide torque motors, may save vertical space (vertical space would simply be limited by minimal code requirements for hoistway height) and reduce friction in the overall system, thereby permitting less backlash and smaller torque requirements for each motor. In some embodiments, the rotor 212 may be attached to the drive unit screw 204 via a coupling 216. As discussed above, the coupling 216 may assist the motor unit 208 in rotating the drive unit screw 204 by absorbing misalignment between the drive unit screw and the motor unit, thereby limiting the moments on both the drive unit screw and motor unit, which may otherwise lead to damage or wear. Moreover, the coupling 216 may provide a degree of flexibility that can reduce the vibrations and shock loads that are transmitted from the motor unit 208 to attached components (e.g., drive unit screws, drive unit nuts, brakes, etc.), thereby improving the overall performance of the system. In some embodiments, the suspension frame 232 may also include guide members 224, 226, 228, 230 that are in contact with the first and second guide rails 218, 220 and the carrying platform 222. The guide members 224, 226, 228, 230 may facilitate the single axis movement of the carrying platform 222 by helping maintain the carrying platform's balance and stability as it moves along the guide rails 218, 220. Guide members may include (but are not limited to) roller guide shoes or slide guide shoes.

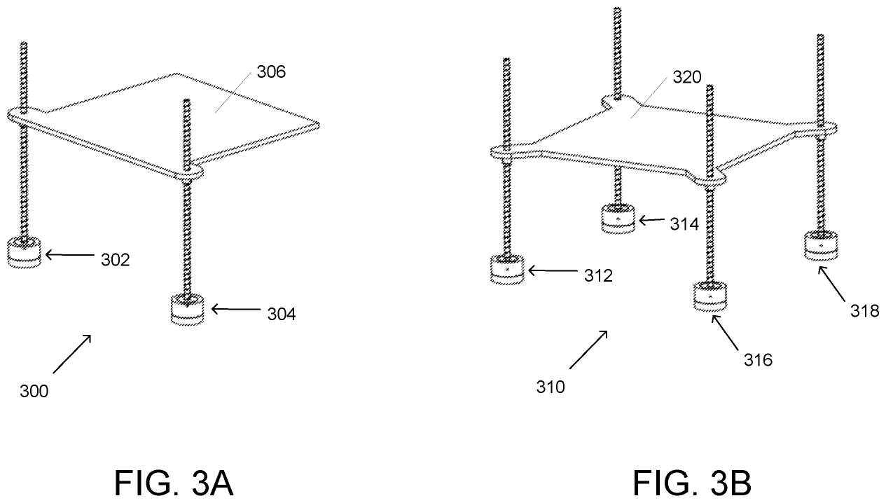

As described above, stationary motor drive systems may include two drive units, each of which may be located on opposite sides of the lift (as illustrated in FIG. 1). This may allow for a symmetrical center pickup of the carrying platform of the lift, which may help maintain the carrying platform's stability and balance as it moves between floors. Moreover, operating synchronized motors with a symmetrical center pickup may reduce the moment on guide rails, thereby reducing power and torque output needs for distributed drive systems. However, as discussed above, the use of multiple, synchronized motors allows for flexible lift configurations, so stationary motor drive systems need not be limited to the use of any particular number of drive units or drive unit placements. Schematic diagrams illustrating a left perspective view of alternative embodiments of a stationary motor drive system for a lift in accordance with an embodiment of the invention is shown in FIGS. 3A-3B. As illustrated in FIG. 3A, the stationary motor drive system 300 may include two drive units (e.g., drive units 302, 304) that may be located on the same side of the carrying platform 306 of the lift 300. When dynamic loading is not even, the use of synchronized motors permits the motor responsible for or assigned to the load to increase or decrease its torque output and maintain its position (in motion or stopped) in line with the other motor(s), as further described below. This may alleviate the need for distributed drive systems to have additional structural systems that are robust enough to compensate for offset loads. In another alternative embodiment, as illustrated in FIG. 3B, the stationary motor drive system 310 may include more than two drive units (e.g., drive units 312, 314, 316, 318) that may be located on all sides of the carrying platform 320 of the lift 310.

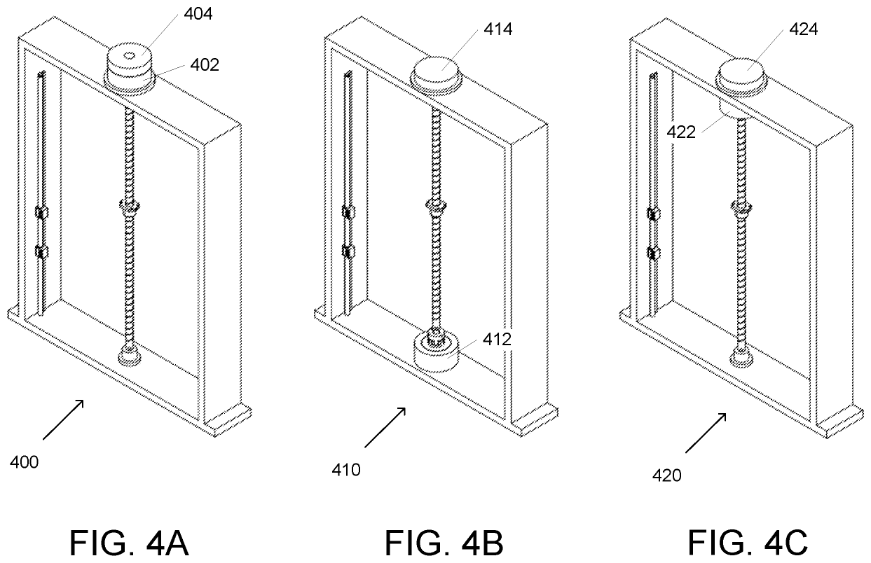

Schematic diagrams illustrating a right perspective view of other alternative embodiments of a stationary motor drive system for a lift in accordance with an embodiment of the invention is shown in FIGS. 4A-4C. As described above, in some embodiments, the motor units and brakes may be attached to the bottoms of the suspension frames and positioned concentrically to the drive unit screws and drive unit nuts. However, the motor units and brakes may be attached in various other locations and positions within stationary motor drive systems, and may not be attached to one another. For example, in some embodiments, as illustrated in FIG. 4A, the motor unit 402 may rest on, and be attached to, the top of the suspension frame 400 using methods known to one of skill in the art, and the brake 404 may rest on, and be attached to, the top of the motor unit 402 using methods known to one of skill in the art. In alternative embodiments, as illustrated in FIG. 4B, the motor unit 412 may rest on, and be attached to, the bottom of the suspension frame 410, while the brake 414 may rest on, and be attached to, the top of the suspension frame 410. In further embodiments, as illustrated in FIG. 4C, the brake 424 may rest on, and be attached to, the top of the suspension frame 420, and the motor unit 422 may be attached to the underside of the top of the suspension frame 420.

Although stationary motor distributed drive systems using synchronous rotational motion are discussed above with respect to FIGS. 1-4C, any of distributed drive systems including stationary motor distributed drive systems using various configurations as appropriate to the requirements of a specific application can be utilized in accordance with embodiments of the invention. Traveling motor drive systems utilizing synchronous rotational motion in accordance with embodiments of the invention are further discussed below.

### Traveling Motor Drive Systems

Traveling motor drive systems may include motors that travel. In addition to benefits that may be attributed to stationary motor drive systems, traveling motor drive systems may further reduce the number of mechanical and transmission elements within each drive unit. Consequently, traveling motor drive systems may have smaller footprints and further reduce the friction within the overall distributed drive system, thereby permitting increased travel distances. Traveling motor drive systems may also allow for entry/exit from all sides of the lift and may be configurable for use with designs that have minimal car frames, including (but not limited to) glass elevators.

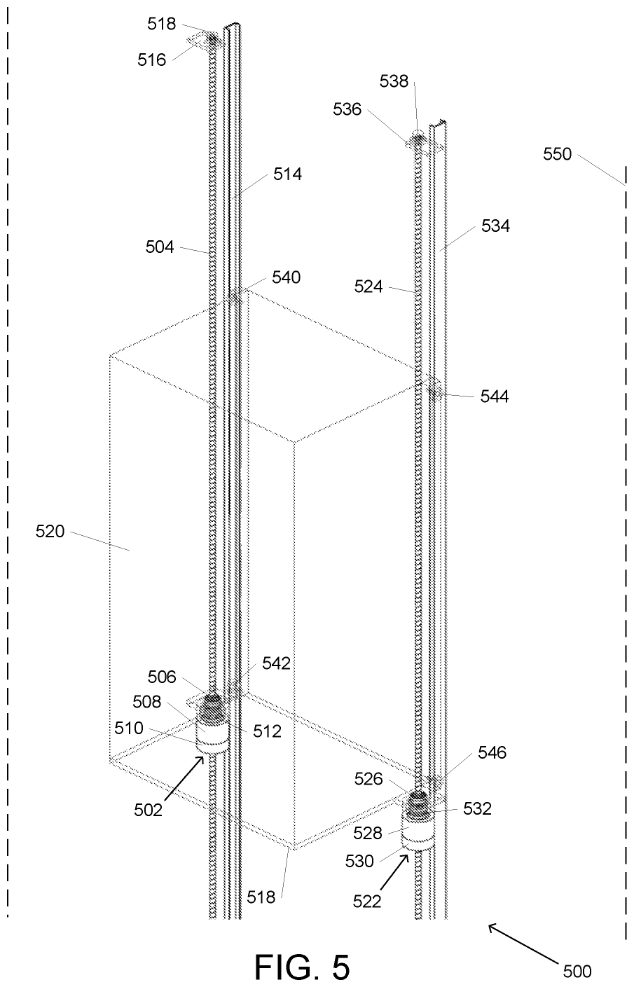

A schematic diagram illustrating a left perspective view of a traveling motor distributed drive system for a lift in accordance with an embodiment of the invention is shown in FIG. 5. The traveling motor drive system 500 includes a first drive unit 502 that includes a first drive unit screw 504, a first motor unit 508, and a first drive unit nut 506. The traveling motor drive system 500 may also include a second drive unit 522 that includes a second drive unit screw 524, a second motor unit 528, and a second drive unit nut 526. The first motor unit 508 may be positioned concentrically to the first drive unit screw 504 and the first drive unit nut 506. The first motor unit 508 may encircle the first drive unit screw 504. In many embodiments, the first motor unit 508 may be configured to synchronously rotate the first drive unit nut 506, as further described below. In addition, the second motor unit 528 may be positioned concentrically to the second drive unit screw 524 and the second drive unit nut 526. The second motor unit 528 may encircle the second drive unit screw 524. In various embodiments, the second motor unit 528 may be configured to synchronously rotate the second drive unit nut 526, as further described below. Because the first and second motor units 508, 528 are configured to rotate the first and second drive unit nuts 506, 526, respectively, instead of the first and second drive unit screws 504, 524, respectively, the load inertia (i.e., measure of the amount of energy required to accelerate/decelerate a load that is rotating) of the overall system may be reduced. In some embodiments, the first and second motor units 508, 528 may be torque motor units such as (but not limited to) hollow-bore permanent magnet torque motors (hereinafter referred to as “hollow-bore PM torque motors”).

In reference to FIG. 5, the first and second motor units 508, 528 may be attached to the first and second drive unit nuts 506, 526, respectively, via couplings 512, 532 that assist the first and second motor units 508, 528 in translating the rotational motion and torque generated by the motor units to the drive unit nuts, as further described below. In many embodiments, the first and second drive units 502, 522 also include first and second brakes 510, 530 respectively, that are engaged by default and are released as the first and second motor units 508, 528 rotate the first and second drive unit nuts 506, 526, respectively. In some embodiments, the first and second brakes 510, 530 are attached to the bottoms of the first and second motor units 508, 528, respectively, but may be located elsewhere, as further discussed below. In many embodiments, the first and second drive unit screws 504, 524 are oriented along the hoistway 550 of the lift, and the first and second drive unit nuts 506, 526 are configured to travel the helical thread of the first and second drive unit screws 504, 524, respectively, as the drive unit nuts 506, 526 rotate around the first and second drive unit screws 504, 524.

In further reference to FIG. 5, the first and second drive unit nuts 506, 526 encircle the drive unit screws 504, 524, respectively, and are in contact with both the first and second drive unit screws 504, 524, respectively, and the carrying platform 518 of the lift. In various embodiments, the first and second drive unit nuts 506, 526 may be secured to the carrying platform 518 using methods known to one of skill in the art such that the load of the carrying platform 518 rests on the first and second drive unit nuts 506, 526, as further described below. Additionally, in many embodiments, the first and second motor units 508, 528 may be secured to the carrying platform 518 using methods known to one skilled in the art, as further described below. When the first and second drive unit nuts 506, 526 travel along the helical threads of the first and second drive unit screws 504, 524, respectively, the carrying platform 518 and first and second motor units 508, 528 may also travel along the hoistway 550 of the lift. Permitting the first and second motor units 508, 528, and thus the entire first and second drive units 502, 522, to travel with the carrying platform 518 may allow for further elimination of transmission elements within drive units, thereby reducing friction (thus reducing torque output requirements) and increasing efficiency of the overall distributed drive system.

In further reference to FIG. 5, the first and second drive unit screws 504, 524 may be suspended in tension along the hoistway 550 of the lift and secured at the top of the hoistway 550 via first and second suspension nuts 518, 538, respectively. The first and second drive unit screws 504, 524 may be secured at the top of the hoistway 550 to prevent the first and second drive unit screws 504, 524 from also rotating as the first and second drive unit nuts 506, 526 rotate around the first and second drive unit screws 504, 524, respectively. In many embodiments, the first and second suspension nuts 518, 538 may be secured to the top of the hoistway 550 by suspension members 516, 536, respectively. In some embodiments, the carrying platform 518 may be configured to travel along first and second guide rails 514, 534 that limit the carrying platform's 518 movement to a single axis along the guide rails themselves and that keep the carrying platform aligned with landing floors. In various embodiments, the first and second guide rails 514, 534 may be oriented parallel to the first and second drive unit screws 504, 524, respectively. Moreover, the first and second guide rails 514, 534 may help to limit the moment on the first and second drive unit nuts 506, 526 as the carrying platform 518 travels. In some embodiments, the traveling motor drive system 500 may include guide members 540, 542, 544, 546 that are in contact with the first and second guide rails 514, 534 and the carrying platform 518. The guide members 540, 542, 544, 546 may maintain the carrying platform's 518 alignment and reduce friction between the carrying platform 518 and the first and second guide rails 514, 534 as the carrying platform 518 travels along the first and second guide rails 514, 534. Guide members may include (but are not limited to) roller guides or slide guide shoes.

As described above, some embodiments of distributed drive systems may utilize torque motors to rotate the drive unit screws and/or drive unit nuts. Torque motors such as hollow-bore PM torque motors have a large number of magnetic poles that allow for generation of high torque at low speeds. This permits motors that directly drive the drive unit nuts to meet the various mechanical rotational speeds as required by the lift, and even maintain a stopped position without the need for brakes. Moreover, the hollow-bore configuration (i.e., space within the rotor is hollow) may allow for an empty motor shaft that eliminates the need for additional transmission elements surrounding the drive unit screw and may allow for the rotor to be attached directly to the drive unit nut. Furthermore, the torque output of hollow-bore PM torque motors is proportional to the square of the motor's rotor diameter; thus, a small increase in diameter may lead to a large increase in torque output. A limitation on the diameter may be the lateral distance between the screws and the carrying platform of the lift. However, if the desired diameter cannot be obtained because there is insufficient lateral space, then the hollow-bore PM torque motor's length may be increased until sufficient torque is delivered as torque is linearly proportional to motor length.

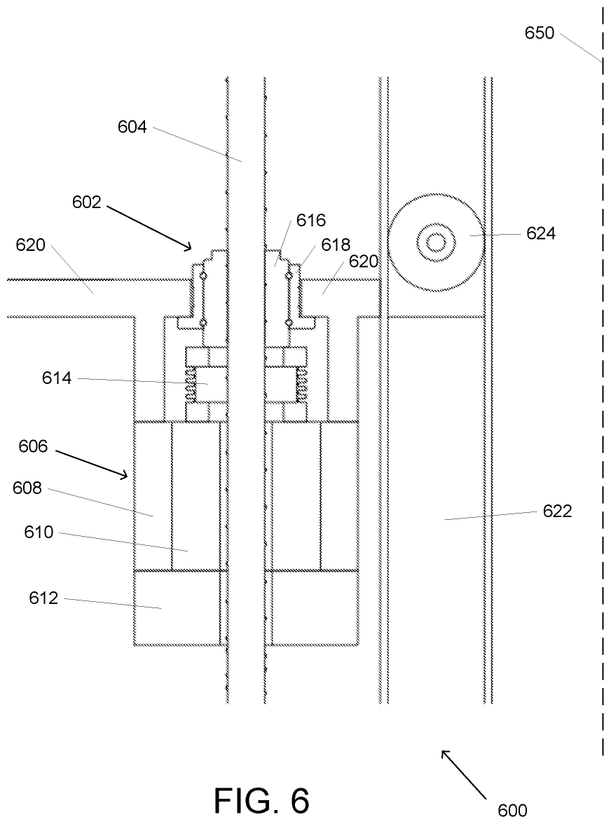

A schematic diagram illustrating a cross section view of a drive unit of a traveling motor distributed drive system for a lift in accordance with an embodiment of the invention is shown in FIG. 6. In many embodiments, the motor unit 606 may be secured to the carrying platform 620 and encircle the drive unit screw 604 such that it is concentric with both the drive unit screw 604 and the drive unit nut 602. The drive unit screw 604 is suspended in tension along the length of the hoistway 650 of the lift. In many embodiments, the motor unit 606 may be a torque motor unit that includes a rotor 610 and a stator 608 attached to the brake 612. In various embodiments, the drive unit nut 602 may include a rotating inner ring 616 attached to the rotor 610 and in contact with the drive unit screw 604 and a non-rotating outer ring 618 attached to the stator 608 and the carrying platform 620. In some embodiments, a non-rotating outer ring 618 may be utilized to also serve as a thrust spherical plain bearing that further limits the moments on the outer ring 618 and/or the stator 608, and may be optimized, using methods known to one of skill in the art, for low friction. In many embodiments, the non-rotating outer ring 618 may be secured to the carrying platform 620 using methods known to one of skill in the art such that the load of the carrying platform 620 rests on both the non-rotating outer ring 618 and the stator 608. When the rotor 610 rotates the inner ring 616, the drive unit nut 602 travels the helical thread of the drive unit screw 604, and consequently the entire motor unit 606 and carrying platform 620 may travel along the hoistway 650 of the lift. In alternative embodiments, the stator 608 may be secured to the carrying platform 620 using methods known to one of skill in the art such that the carrying platform 620 rests directly on the stator 608 and such that the load of the carrying platform 620 is borne entirely by bearings between the rotor 610 and stator 608. In some embodiments, the rotor 610 may be attached to the rotating inner ring 616 of the drive unit nut 602 via a coupling 614. In various embodiments, the coupling 614 may assist the motor unit 606 in rotating the inner ring 616 by absorbing misalignment between the drive unit nut 602 and the motor unit 606, thereby limiting the moments on both the drive unit nut 602 and the motor unit 606, which may otherwise lead to damage or wear. Moreover, the coupling 614 may provide a greater degree of flexibility that can reduce the vibrations and shock loads that are transmitted from the motor unit 606 to attached components (e.g., drive unit screws, drive unit nuts, brakes, etc.), thereby improving the overall performance of the system. In some embodiments, the carrying platform 620 may also be in contact with a guide member 624 that is in contact with a guide rail 622.

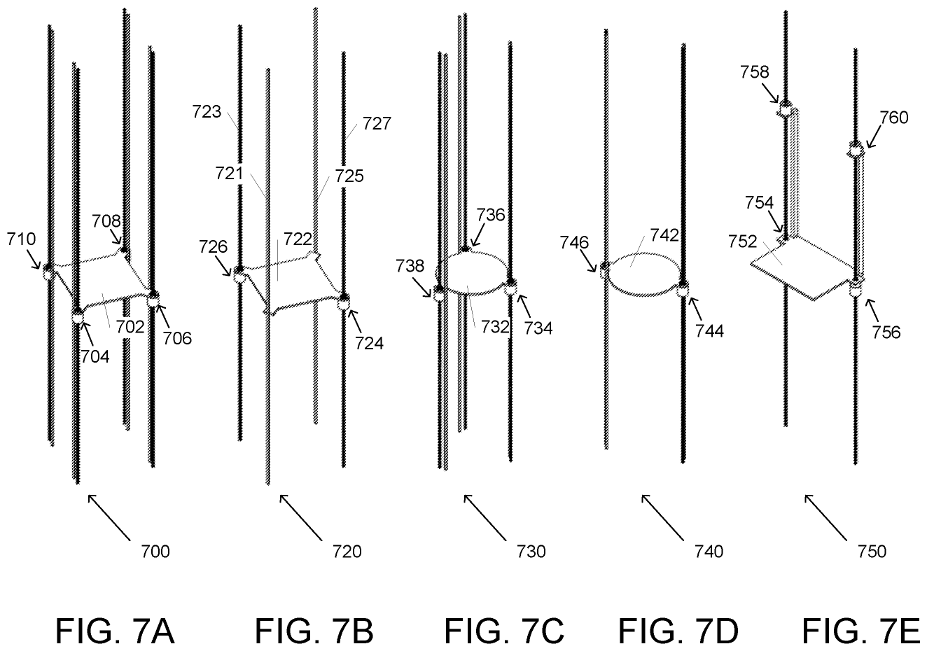

As described above, traveling motor drive systems may include two drive units, each of which may be located on one side of the lift (as illustrated in FIG. 5). In reference to FIG. 5, a cantilever implementation is illustrated. An advantage of this embodiment of the traveling motor drive system is that that the system allows the center of mass offset to only have to be accommodated in a single axis. In prior art systems, it would take much effort having to accommodate an offset center of mass in the second, less critical, axis and has required a lot of redesign of carrying platforms. However, as previously discussed, the use of multiple, synchronized motors allows for flexible lift configurations, so traveling motor drive systems need not be limited to the use of any particular number of drive units or drive unit placements. Schematic diagrams illustrating a left perspective view of alternative embodiments of traveling motor distributed drive systems for a lift in accordance with an embodiment of the invention are shown in FIGS. 7A-7E. As illustrated in FIG. 7A, the traveling motor drive system 700 may include more than two drive units (e.g., drive units 704, 706, 708, 710) that may be located on all sides of the carrying platform 702 of the lift 700. In another alternative embodiment, as illustrated in FIG. 7B, the traveling motor drive system may include two drive units (e.g., drive units 726, 724) while including two guide rails (e.g., guide rails 721, 725) and two screws (e.g., screws 723, 727) for the carrying platform 722 for the lift 720. In another alternative embodiment, as illustrated in FIG. 7C, the traveling motor drive system may include an uneven number of drive units (e.g., drive units 734, 736, 738) and may be configured for a non-polygon shaped carrying platform 732 for the lift 730. In another alternative embodiment, as illustrated in FIG. 7D, the traveling motor drive system may include two drive units (e.g., drive units 744, 746) and may be configured for a non-polygon shaped carrying platform 742 for the lift 740. In another alternative embodiment, as illustrated in FIG. 7E, the traveling motor drive system may include more than two drive units (e.g., drive units 754, 756, 758, 760) that may be located on the same side of the carrying platform 752 and may be attached directly to the carrying platform 752 for the lift 750. When dynamic loading is not even, the use of synchronized motors permits the motor responsible for or assigned to the load to increase or decrease its torque output and maintain its position (in motion or stopped) in line with the other motor(s), as further described below. This may alleviate the need for distributed drive systems to have additional structural systems that are robust enough to compensate for offset loads

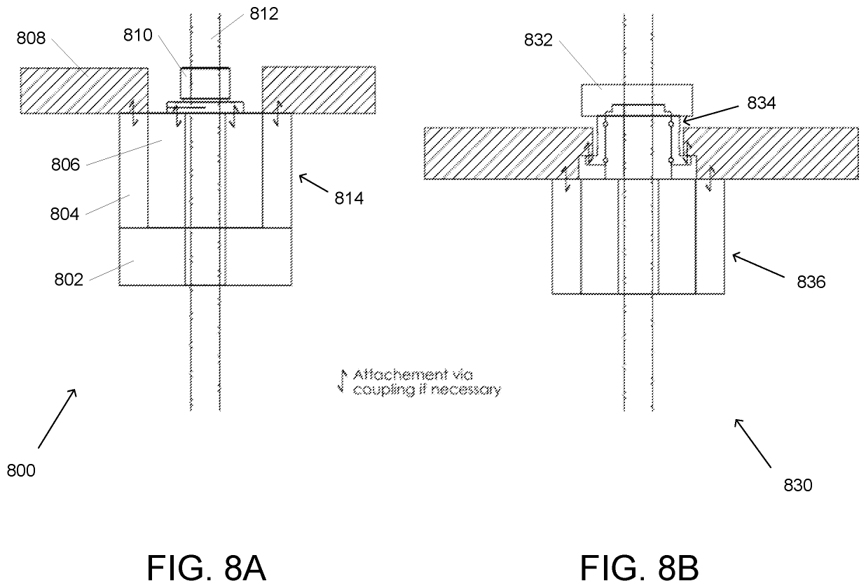

Schematic diagrams illustrating a cross-section view of alternative embodiments of a drive unit of traveling motor distributed drive systems for a lift in accordance with an embodiment of the invention are shown in FIGS. 8A-8B. As described previously, in some embodiments, the carrying platform of the lift may be attached to the non-rotating outer ring of the drive unit screw. However, in some embodiments, as illustrated in FIG. 8A, the carrying platform of the lift 808 may be attached directly or via coupling to the stator 804 of the motor unit 814. This may allow for a drive unit nut 810 that does not include a non-rotating outer ring. As described above, in some embodiments, the brake 802 may be attached to the bottom of the motor unit 814. However, the motor units and brakes may be attached in various other locations and positions within traveling motor drive systems, and may not necessarily be attached to each other. For example, in some embodiments, as illustrated in FIG. 8B, the brake 832 may not be attached to the motor unit 836 and may instead be attached to the top of the drive unit nut 834 which may include a rotating inner ring and a non-rotating outer ring of the drive unit 830. In some embodiments, the components might be attached via coupling and/or attached directly known to one of skill in the art.

Although specific traveling motor distributed drive systems using synchronous rotational motion are discussed above with respect to FIGS. 5-8B, any of a variety of distributed drive systems including traveling motor distributed drive systems using various configurations as appropriate to the requirements of a specific application can be utilized in accordance with embodiments of the invention. Synchronization of motor units for distributed drive systems in accordance with embodiments of the invention are discussed further below.

### Synchronization of Motor Units

Distributed drive systems (e.g., stationary motor distributed drive systems or traveling motor distributed drive systems) may utilize motor units that are synchronized. Synchronized motors may permit distributed drive systems to operate lifts more efficiently, reliably, and safely. When motors are synchronized, they work together to produce a consistent and coordinated output to raise and lower the carrying platform of a lift, which may help distribute the load evenly between the motors, thereby reducing unnecessary strain on any one motor. Consequently, having synchronized motors, and thus synchronized drive units, may reduce the overall power required to operate the lift. Moreover, synchronized motors generally allow for symmetrical center pickup, which may minimize concerns regarding offset loads on the carrying platform. Furthermore, as described above, distributed drive systems may also utilize torque motors to directly drive the lift. The use of torque motors capable of producing high torque at low speeds (or maintaining a stopped position) may allow for precise synchronization of multiple motors.

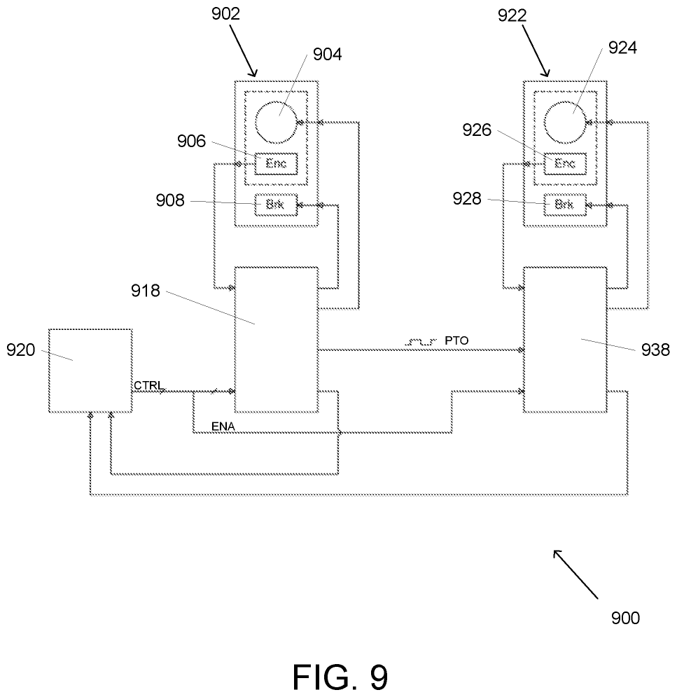

A block diagram illustrating a control feedback module of a distributed drive system for a lift in accordance with an embodiment of the invention is shown in FIG. 9. The control feedback module 900 coordinates motor output by synchronizing position or speed of such motors, as further described below. In some embodiments, the control feedback module may synchronize position, speed, or torque. In some embodiments, the control feedback module may be configured for synchronizing position. For example, if one side has a sudden increase in load (e.g., someone jumps on one side), then the motor(s) closest to that side may require increased drive voltage output for synchronization of position. As the priority is to keep the carrying platform level, the drive voltage each motor receives may be different to move to a particular position to stay synchronized with the other motor(s). In many embodiments, position may be the most precise, then speed, then torque for error correction.

The control feedback module 900 is operatively connected to a first drive unit 902 that includes a first motor unit 904 and a first motor encoder 906. In many embodiments, the first drive unit 902 may also include a first brake 908. The control feedback module 900 may also be operatively connected to a second drive unit 922 that includes a second motor unit 924 and a second motor encoder 926. In many embodiments, the second drive unit 922 may also include a second brake 928.

In reference to FIG. 9, the first drive unit 902 may include a first drive module 918. In many embodiments, the first drive module 918 may be a variable frequency drive (hereinafter referred to as “VFD”). The second drive unit 922 may include a second drive module 938. In many embodiments, the second drive module 938 may also be a VFD. The control feedback system 900 may include a controller 920 such as (but not limited to) a programmable logic controller or microcontroller configured to monitor the first and second motor units 904, 924, as further described below.

In further reference to FIG. 9, the control feedback module 900 may synchronize the first and second motor units 904, 924 using various control mechanisms for motor synchronization such as, but not limited to, master-slave control. When utilizing master-slave control, the first drive module 918 of the first motor unit 904 (i.e., the master motor) controls the speed and/or position of the second motor unit 924 (i.e., the slave motor), as further described below. In many embodiments, the second motor unit 924 may adjust its speed and/or position to match that of the first motor unit 904, ensuring that the first and second motor units 904, 924 operate in sync, as further discussed below. Master-slave control is a simple, cost-effective, and reliable method of motor synchronization. It requires few sensors and minimal control hardware, allows for precise synchronization of motors without complex control algorithms (thereby making it less prone to error or malfunction), can synchronize motors with different characteristics and operating parameters, and can be easily scaled to control a large number of motors. However, the control feedback module 900 need not be limited to master-slave control to synchronize the first and second motor units 904, 924. For example, the control feedback module 900 may utilize any number of synchronization methods known to one of skill in the art, such as (but not limited to) electronic line-shafting, load sharing, cross-coupling, decentralized synchronization, and network synchronization. Moreover, these methods can be combined and customized to suit specific lift applications, and the choice of method may depend on the level of precision (e.g., error correction) required, the type of load, and the operating environment. Furthermore, some motor control systems may have built-in features that allow for automatic motor synchronization. These systems may use sensors and/or other feedback mechanisms to detect any differences in motor position or speed, thereby automatically adjusting motor control to keep the motors in sync. For example, in some embodiments, feedback mechanisms may include power and/or energy. In some embodiments, power and/or energy may include, but is not limited to, various signals in the form of various phases (e.g., three phases) to power the motor at a certain speed.

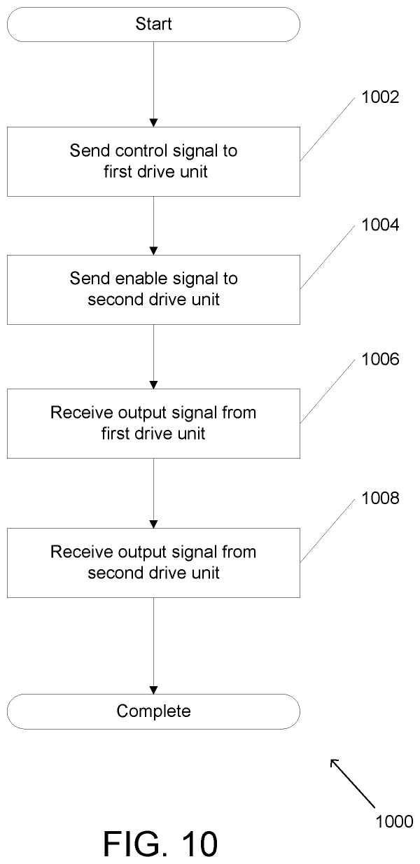

A flow diagram illustrating a process of synchronization monitoring of a first drive unit and a second drive unit by a controller in accordance with an embodiment of the invention is shown in FIG. 10. The process 1000 may include the controller generating and sending (1002) a control signal to the first drive unit or to multiple drive units. In some embodiments, the control may provide a target position to the first drive module 918 which is then used to regulate the position and/or speed of the first motor unit. For example, the controller 920 may be configured to provide a target position (e.g. a first floor) and the first drive module 918 may be configured to regulate the position of the motors as further described above. In some embodiments, the first drive module 918 may be configured to automatically be a master and send off information to a slave (e.g., the second drive module 938). In some embodiments, the controller 920 may be configured to have no idea there is a slave motor involved, except to stop the component via enable signal. In some embodiments, the control signal regulates the speed and/or position of the motors to keep them synchronized. However, the control signal may also include other parameters, such as (but not limited to) acceleration and deceleration rates and other VFD parameters. In some embodiments, acceleration and deceleration and other VFD parameters may also be set in the first drive module 918. By setting such parameters, the controller may allow for smooth acceleration and deceleration s-curves when approaching and departing floor levels, as opposed to utilizing a simple two-speed system. The process 1000 may also include the controller generating and sending (1004) an enable signal to the second drive unit. In many embodiments, the system may want the ability to immediately stop (or limit operation) of all machines from the controller 920. In some embodiments, the enable signal enables or disables the drive modules. When the enable signal is high, the motors may synchronize and work together to move the carrying platform of the lift. When the enable signal is low, the motors may be prevented from synchronizing. Thus, the enable signal may ensure that motors are active only when the controller permits it (e.g., during operation of the lift). This may help to ensure the safety and efficiency of distributed drive systems, (e.g., individual motors can be disabled if necessary or during maintenance). In some embodiments, the controller 920 may be connected to and move the various components directly from the drives (e.g., first and second drive modules 918, 938).

The process 1000 may further include the controller receiving (1006) an output signal from the first drive unit 1006, as further described below. In addition, the process 1000 may include the controller receiving (1008) an output signal from the second drive unit 1008, as further described below. In many embodiments, the controller may use the information from these output signals to determine operational information and parameters such as (but not limited to) speed, position, acceleration/deceleration rates, and/or torques of the motors, and may adjust output to the drive modules accordingly.

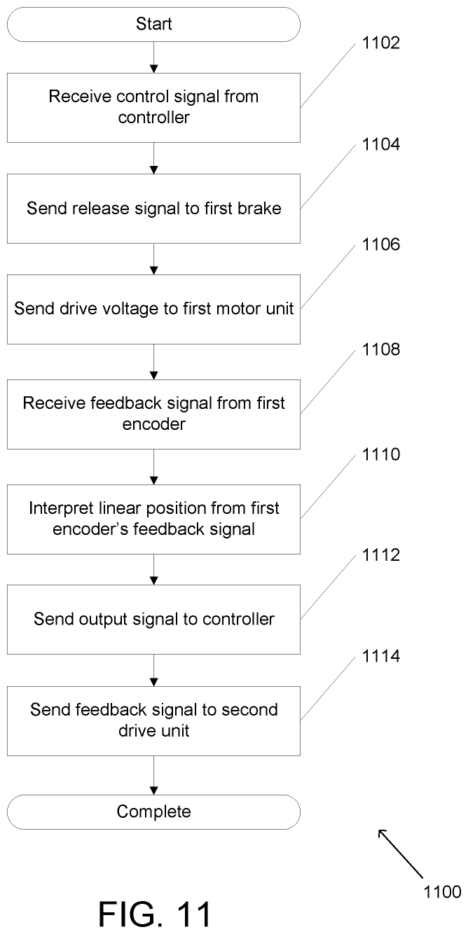

A flow diagram illustrating a process of motor synchronization by a first drive module in accordance with an embodiment of the invention is shown in FIG. 11. The process 1100 may include the first drive module receiving (1102) the control signal from the controller. The process 1100 may further include the first drive module sending (1104) a release signal to the first brake. As discussed above, the first brake may be engaged by default and released as the first drive module drives the first motor unit. The process 1100 may also include the first drive module sending (1106) a drive voltage to the first motor unit to begin driving the first motor unit. As the first drive module drives the first motor unit, the process 1100 may include the first drive module receiving (1108) a feedback signal from the first motor encoder. Although other sensors may be used to provide this feedback signal, they are not required. The first motor encoder may measure the rotary position of the first motor unit, which is then encoded as error feedback data into the feedback signal.

In reference to FIG. 11, the process 1100 may further include the first drive module interpreting (1110) the linear position of the carrying platform of the lift from the rotary position of the first motor unit. In addition, the process 1100 may include the first drive module sending (1112) operational information and the speed, rotary position, and linear position information to the controller via an output signal for further monitoring, and also sending (1114) information via a feedback signal to the second drive unit. In some embodiments, the first drive module may simply send an acknowledgement signal back to the controller when a task is completed (and with general error info also). As described above, some embodiments of distributed drive systems may utilize VFDs to drive the motor units that then rotate the drive unit screws and/or drive unit nuts. In some embodiments, as the controller monitors the synchronization of the motor units (as illustrated in FIG. 10), motor position or speed may need to be adjusted to ensure motor units are operating in sync. This may be done by changing the output voltage (or motor voltage, drive voltage, or three-phase voltage) (i.e., drive) sent to the motor unit by the VFD. Additionally, because VFDs may be configured to interpret linear position data, floor levels may be programmed into the control feedback module, which may remove the need for mechanical floor level and floor zone sensors. Thus, other than switches for safety, no other mechanical position sensors may be necessary unless required by location-specific code.

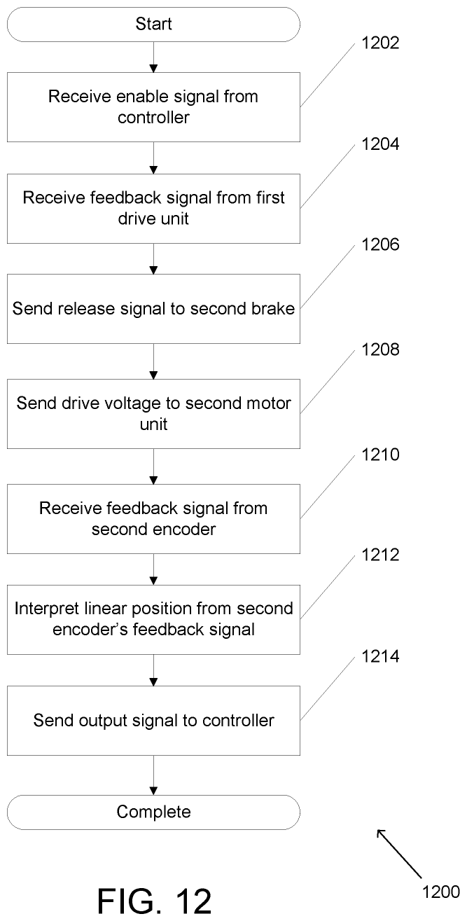

A flow diagram illustrating a process of motor synchronization by a second drive module in accordance with an embodiment of the invention is shown in FIG. 12. The process 1200 may include the second drive module receiving (1202) the enable signal from the controller and also receiving (1204) the feedback signal from the first drive unit (e.g., speed and/or position info of the first motor unit). The process 1200 may further include the second drive module sending (1206) a release signal to the second brake. As discussed above, the second brake may be engaged by default and released as the second drive module drives the second motor unit. The process 1200 may also include the second drive module sending (1208) a drive voltage to the second motor unit to begin driving the second motor unit. As the second drive module drives the second motor unit, the process 1200 may include the second drive module receiving (1210) a feedback signal from the second motor encoder. Although other sensors may be used to provide this feedback signal, they are not required. The second motor encoder may measure the rotary position of the second motor unit, which is then encoded as error feedback data into the feedback signal.

In reference to FIG. 12, the process 1200 may further include the second drive module interpreting (1212) the linear position of the carrying platform of the lift from the rotary position of the second motor unit. The second drive module may incorporate both the feedback signal from the first drive unit and the feedback signal from the second motor encoder to drive the second motor unit in sync with the first motor unit. In addition, the process 1200 may include the second drive module sending (1214) operational information and the speed, rotary position, and linear position information to the controller via an output signal for further monitoring. In some embodiments, the second drive module may simply send an acknowledgement signal back to the controller when a task is completed (and with general error info also). As described above, some embodiments of distributed drive systems may utilize VFDs to drive the motor units that then rotate the drive unit screws and/or drive unit nuts. In some embodiments, as the controller monitors the synchronization of the motor units (as illustrated in FIG. 10), motor position or speed may need to be adjusted to ensure motor units are operating in sync, as further described above. Additionally, because VFDs may be configured to interpret linear position data, floor levels may be programmed into the control feedback module, which may remove the need for mechanical floor level and floor zone sensors, as further described above.

Although specific processes for synchronization of motor units for distributed drive systems are discussed above with respect to FIGS. 9-12, any of a variety of processes for synchronization of motor units for distributed drive systems as appropriate to the requirements of a specific application can be utilized in accordance with embodiments of the invention. For example, processes for synchronization of motor units for disturbed drive systems may include, but are not limited to, a centralized, master-slave, master-slave chain, or decentralized synchronization process. As way of example, in a centralized configuration, a controller may be the micromanager and instruct each drive unit exactly where to move the motor. In a master-slave configuration, a controller may provide a drive unit a target position to go to (and that drive unit may go there) and the drive unit may instruct each other drive unit where its motor is and to send their motors there to match its current position as it moves. In a master-slave chain configuration, a controller may provide a drive unit a target position to go to (and that drive unit goes there) and the drive unit instructs the next drive unit (which tells the next drive unit, etc.) to send its motor to match its current position as it moves. In a decentralized configuration, a controller may provide all drive units a target position to go to, and each node (e.g., drive unit) calculates where to send its motors to based on feedback from its adjacent nodes through an error calculation performed internally.

While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A distributed drive system for a lift, the distributed drive system comprising:
a first drive unit comprising:
a first drive unit screw comprising a helical thread, wherein the first drive unit screw is oriented along a hoistway of the lift;
a first motor unit concentric to the first drive unit screw, wherein the first motor unit is configured to rotate the first drive unit screw; and
a first drive unit nut in contact with the first drive unit screw and in contact with a carrying platform of the lift, wherein the first drive unit nut is configured to travel a length of the helical thread of the first drive unit screw as the first drive unit screw rotates, causing the first drive unit nut to travel along the hoistway of the lift;
a second drive unit comprising:
a second drive unit screw comprising a helical thread, wherein the second drive unit screw is oriented along the hoistway of the lift;
a second motor unit concentric to the second drive unit screw, wherein the second motor unit is configured to rotate the second drive unit screw; and
a second drive unit nut in contact with the second drive unit screw and in contact with the carrying platform of the lift, wherein the second drive unit nut is configured to travel a length of the helical thread of the second drive unit screw as the second drive unit screw rotates, causing the second drive unit to travel along the hoistway of the lift; and
a control feedback module operatively connected to the first and second drive units, wherein the control feedback module is configured to synchronize position or rotary speed of the first motor unit and the second motor unit.

2. The distributed drive system of claim 1, wherein the control feedback module comprises a controller, and wherein the controller is configured to:
send a control signal to the first drive unit;
send an enable signal to the second drive unit; and
monitor the first motor unit and the second motor unit.

3. The distributed drive system of claim 2, wherein the first drive unit further comprises a first drive module configured to:
receive the control signal from the controller;
send a first drive power to the first motor unit; and
send an operational feedback signal.

4. The distributed drive system of claim 3, wherein the second drive unit further comprises a second drive module configured to:
receive the operational feedback signal from the first drive module;
receive the enable signal from the controller; and
send a second drive power to the second motor unit.

5. The distributed drive system of claim 4, wherein the first drive unit further comprises a first motor encoder configured to:
encode a first set of error feedback data into a first encoder feedback signal; and
send the first encoder feedback signal from the first motor unit to the first drive module.

6. The distributed drive system of claim 5, wherein the second drive unit further comprises a second motor encoder configured to:
encode a second set of error feedback data into a second encoder feedback signal; and
send the second encoder feedback signal from the second motor unit to the second drive module.

7. The distributed drive system of claim 6, wherein the first drive unit further comprises a first brake that is engaged by default and is released by the first drive module.

8. The distributed drive system of claim 7, wherein the second drive unit further comprises a second brake that is engaged by default and is released by the second drive module.

9. The distributed drive system of claim 8, wherein the first brake is attached to the first motor unit, and the second brake is attached to the second motor unit.

10. The distributed drive system of claim 1, the distributed drive system further comprising an at least one suspension frame, wherein the at least one suspension frame comprises a side having a length.

11. The distributed drive system of claim 10, wherein the at least one suspension frame comprises an at least one guide rail oriented along the length of the at least one suspension frame, and wherein the at least one guide rail restricts the carrying platform to a single axis of movement and keeps the carrying platform aligned with landing floors.

12. The distributed drive system of claim 11, wherein the single axis of movement of the carrying platform is along the at least one guide rail.

13. The distributed drive system of claim 12, wherein the at least one guide rail is oriented parallel to the first drive unit screw and the second drive unit screw.

14. The distributed drive system of claim 13, wherein the at least one suspension frame further comprises an at least one limit member guide in contact with the at least one guide rail and in contact with the carrying platform, and wherein the at least one limit member guide maintains the carrying platform's alignment and stability as the carrying platform travels along the at least one guide rail.

15. The distributed drive system of claim 14, wherein the first drive unit screw is suspended in tension along the length of the at least one suspension frame, and the second drive unit screw is suspended in tension along the length of the at least one suspension frame.

16. The distributed drive system of claim 15, the distributed drive system further comprising:
a first suspension nut in contact with the first drive unit screw and in contact with the at least one suspension frame; and
a second suspension nut in contact with the second drive unit screw and in contact with the at least one suspension frame.

17. The distributed drive system of claim 16, wherein the first motor unit is attached to the at least one suspension frame, and the second motor unit is attached to the at least one suspension frame.

18. The distributed drive system of claim 1, wherein the first motor unit is a first torque motor unit, and the second motor unit is a second torque motor unit.

19. The distributed drive system of claim 18, wherein the first torque motor unit comprises a first rotor and a first stator, and wherein the second torque motor unit comprises a second rotor and a second stator.

20. The distributed drive system of claim 19, wherein the first rotor is attached to the first drive unit screw via a first coupling, and wherein the second rotor is attached to the second drive unit screw via a second coupling.
